(19) United States
(12) Patent Application Publication
(10) Pub. No.: US 2020/0281406 A1
(43) Pub. Date: Sep. 10, 2020

(54) METHODS AND SYSTEMS FOR A CONTINUOUS FRYER

(71) Applicant: PPM TECHNOLOGIES HOLDINGS, LLC, Newberg, OR (US)

(72) Inventor: Devin Reeser, Portland, OR (US)

(21) Appl. No.: 16/796,827

(22) Filed: Feb. 20, 2020

Related U.S. Application Data
(60) Provisional application No. 62/810,690, filed on Feb. 26, 2019.

(51) Int. Cl. A47J 37/12

(52) U.S. Cl. CPC A47J 37/1214; A47J 37/129; A47J 37/1247

(57) ABSTRACT

Methods and systems are provided for a rotating continuous fryer. In one example, an oil reservoir of the continuous rotating fryer is heated by a heating cartridge, the heating cartridge comprising tubing with a branched, sinuous geometry attached to a base plate. Furthermore, the rotating continuous fryer has an upper portion, adapted to pivot away from a lower portion of the fryer about a hinge positioned at an outlet side of the rotating continuous fryer.

### CROSS-REFERENCE TO RELATED APPLICATION

The present application claims priority to U.S. Provisional Application No. 62/810,690, filed Feb. 26, 2019. The entire contents of the above-listed application are hereby incorporated by reference for all purposes.

### FIELD

The present description relates generally to continuous fryers having a heat source.

### BACKGROUND AND SUMMARY

Continuous fryers may be used in food industries for rapid, high throughout oil-based cooking. Food items may be submerged in oil within the continuous fryer and subjected to high temperatures to cook or obtain a desired texture of the food items. A size of a continuous fryer may be reduced in comparison to a continuous fryer with a linearly arranged conveying system by adapting the continuous fryer with a rotatable drum configured to receive food items. The drum may be a mobile rotatable reservoir for positioning food items in and out of oil during a frying process.

The inventors have identified some shortcomings in some continuous fryer systems. As one example, a large volume of oil may be utilized in the linear conveyor belt frying system. Heating of oil in such a large system may result in uneven heat distribution and sluggish transfer of energy through the volume of the oil with cooling of the oil occurring at walls of an oil reservoir. Additionally, a heating device used to transmit heat to the oil may comprise multiple parts and impose difficulty upon removal and installation of the device when replacement is desired.

The inventors herein have recognized potential solutions to inefficiently heated continuous frying systems with unwieldy heating devices. In one example, the issues described above may be addressed by a continuous fryer comprising a stationary lower portion, configured with a reservoir to store oil, an upper portion, coupled to the lower portion by a hinge and pivotable about the hinge, and an immersion tube arranged in the lower portion, configured to heat the oil in the reservoir, the immersion tube adapted with a sinuous, branched geometry. In this way, heat may be distributed through a volume of the oil efficiently, allowing for even heating of the oil.

As one example, the immersion tube may have a planar main portion with side portions arranged on opposite sides of the main portion. The side portions may be continuous with the main portion but configured to extend along a direction perpendicular to a plane of the main portion. An overall geometry of the immersion tube enables oil along walls of an oil reservoir of the continuous fryer to be heated, thereby mitigating cooling of the oil at the walls. The side portions and main portion are coupled to a base plate, together forming a single, continuous unit. The immersion tube is thus configured as a cartridge that may be easily replaced.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a first example of a rotating continuous fryer configured to be heated with a split immersion tube.

FIG. 2 shows an example of a split-immersion tube that may be used to heat oil in the rotating continuous fryer.

FIG. 3 shows a second example of the rotating continuous fryer from a top-down view.

FIG. 4 shows the second example of the rotating continuous fryer from a first perspective view.

FIG. 5 shows the second example of the rotating continuous fryer from a second perspective view.

FIG. 6 shows the second example of the rotating continuous fryer from a first side view.

FIG. 7 shows the second example of the rotating continuous fryer from a second side view.

FIG. 8 shows the first example of the rotating continuous fryer in a closed configuration.

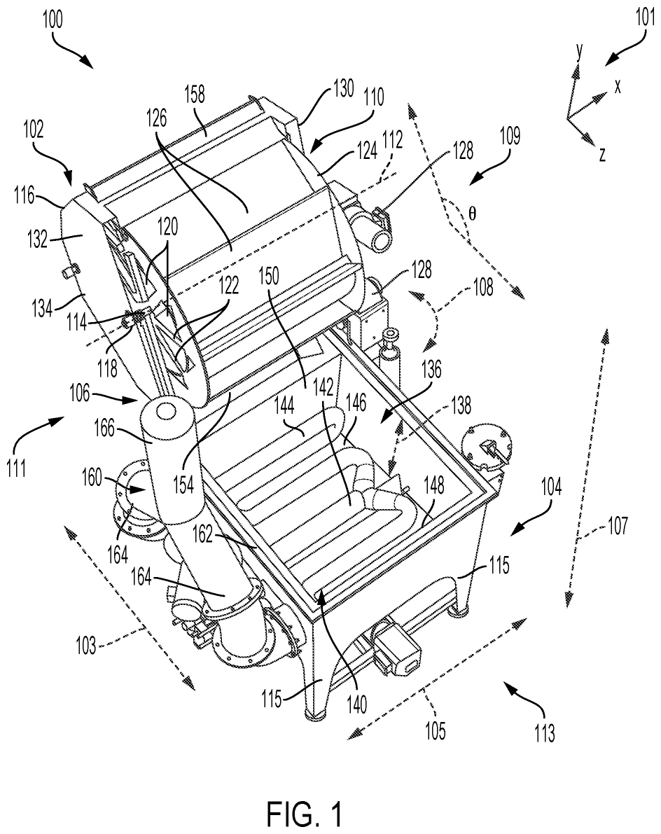

FIGS. 1-8 are shown approximately to scale, however, other relative dimensions may be used if desired.

### DETAILED DESCRIPTION

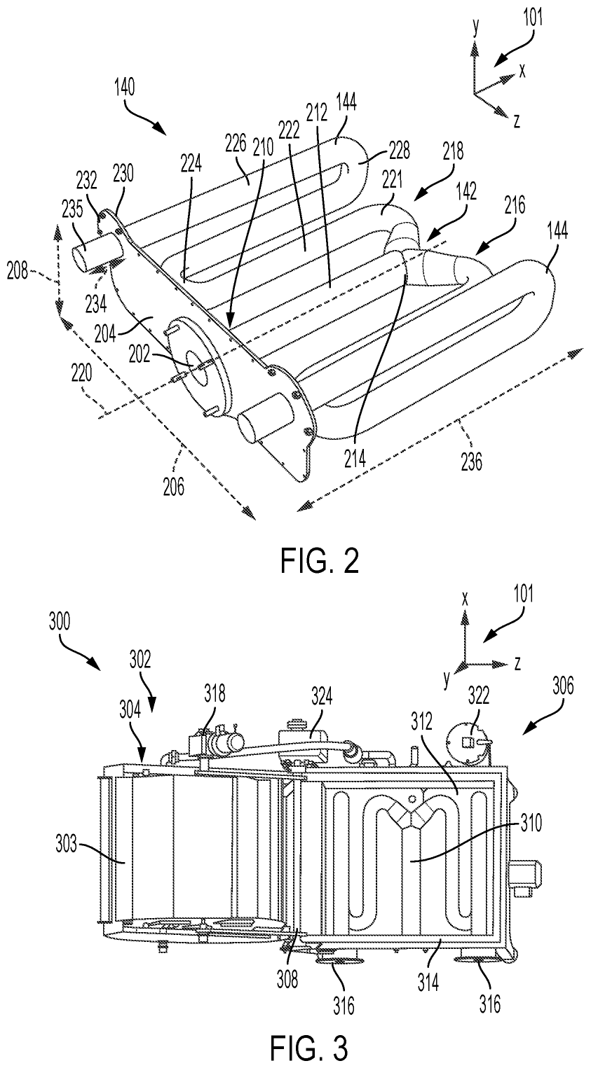

The following description relates to systems and methods for a rotating continuous fryer. In one example, the rotating continuous fryer has a rotating drum to hold and store food items during frying. The rotating drum may be enclosed in and covered by a hood, as shown in a first example of the rotating continuous fryer depicted in FIG. 1. The rotating continuous fryer may be compact in size due to submerging of food items in oil via rotation of the drum rather than along a linear conveying system. Dimensions of the rotating continuous fryer may reduce a volume of oil stored in the fryer to cook food items. The rotating continuous fryer may also include a split-immersion tube, adapted to heat oil stored in a chamber of the fryer and used to cook food items submerged in the oil. An example of the split-immersion tube is illustrated in FIG. 2, showing a sinuous, multi-planar geometry of the split immersion tube. The geometry of the split immersion tube may be configured to heat the oil efficiently, providing even heat distribution through a volume of the oil. The rotating continuous fryer and positioning of various components of the fryer including the arrangement of the split immersion tube within an oil reservoir of the rotating continuous fryer are shown from different views in FIGS. 3-8.

FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Turning now to FIG. 1, a first example of a rotating continuous fryer 100 is shown from a perspective view. A set of reference axis 101 are provided for comparison between views shown, indicating a y-axis, an x-axis, and a z-axis. In one example, the y-axis may be parallel with a vertical direction, the x-axis parallel with a horizontal direction, and the z-axis parallel with a transverse direction.

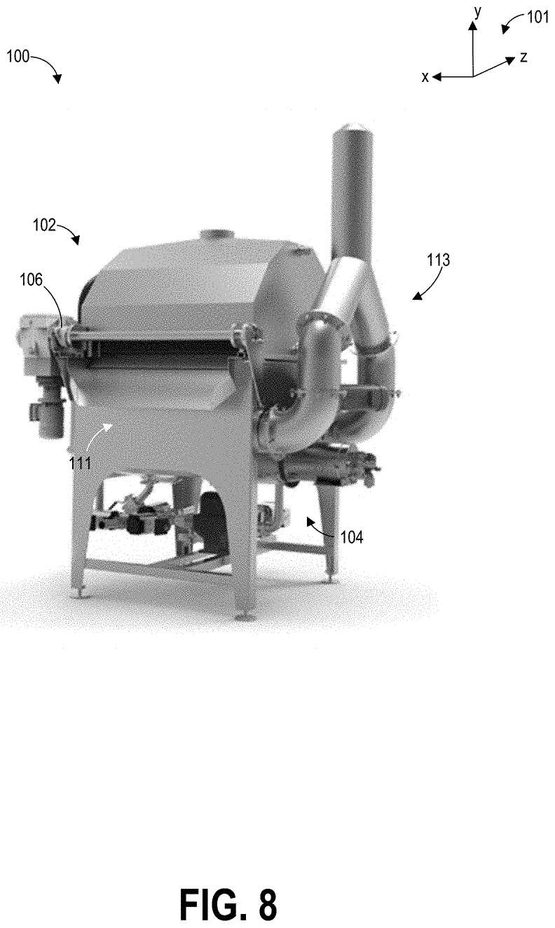

The rotating continuous fryer 100 may have a compact overall geometry with a first width 103, parallel with the z-axis, and a second width 105, parallel with the x-axis, that are either similar in distance or may be slightly different. For example, the first width 103 may be larger or smaller than the second width 105 by a small amount, such as 2-5%. A cross-section of the rotating continuous fryer 100, taken along a z-x plane, may have a square or rectangular shape. A total height 107 of the rotating continuous fryer 100, the height 107 perpendicular to both the first and second widths 103, 105 and parallel with the y-axis, when the rotating continuous fryer 100 is closed, as shown in FIG. 8, (e.g., the rotating continuous fryer 100 is shown open in FIG. 1) may be greater than either the first or second width 103, 105. A cross-section of the rotating continuous fryer 100, taken along the z-x plane, may resemble a dome with a rectangular base that is supported by legs 115, extending below the rectangular base along the y-axis.

The rotating continuous fryer 100 may have an upper portion 102 and a lower portion 104. The lower portion 104 may be configured to be a base for the rotating continuous fryer 100, remaining stationary, while the upper portion 102 may be adapted to be mobile and pivot about a hinge 106 (shown in FIGS. 2, 4, and 5) as indicated by arrow 108. The upper portion 102 may be pivoted continuously between an open position, as shown in FIG. 1, and a closed position, as shown in FIG. 8, where the upper portion 102 is mated with the lower portion 104 in the closed position. The hinge 106 may be arranged at a rear side 111 of the rotating continuous fryer 100 so that the upper portion opens at a front side 113 of the rotating continuous fryer 100.

The hinge 106 may be configured to halt motion of the upper portion 102 and maintain a position of the upper portion 102 when the upper portion 102 is at a specific angle relative to a plane of the lower portion 104, e.g., relative to the z-x plane. For example, the hinge 106 may stop further rotation of the upper portion 102 when the upper portion 102 is positioned at 100° relative to the plane of the lower portion 104, as indicated at 109. Alternatively, the hinge 106 may be adapted to maintain the upper portion 102 at other angles relative to the plane of the lower portion 104, such as 120°, 150°, or 180°. Furthermore, the hinge 106 may be configured to maintain a position of the upper portion 102 at any angle relative to the plane of the lower portion 104 and hold the upper portion 102 at a desired angle until adjusted by a user. In some examples, a motion and/or a sustaining of a position of the upper portion 102 may be adjusted manually or actuated based on hydraulic power and an electric motor.

The upper portion 102 may include a drum 110 that rotates within the rotating continuous fryer 100. The drum 110 may spin around a central axis of rotation 112, rotating about a drum shaft 114 that is parallel with the central axis of rotation 112. The upper portion 102 also includes a hood 116 that is shaped to enclose a portion of the drum 110 and may be a lid for the rotating continuous fryer 100. The drum 110 may be secured to the hood 116 by a drum shaft bearing mount 118 that allows unhindered rotation of the drum 110.

The drum 110 may have a cylindrical overall geometry and be sized to fit within the upper and lower portions 102, 104 of the rotating continuous fryer 100 when the rotating continuous fryer 100 is closed. The drum 110 may be adapted with a plurality of chambers 120 separated by a plurality of chamber walls 122. The plurality of chambers 120 may extend entirely through a width of the drum 110, where the width of the drum 110 is parallel with the second width 105 of the rotating continuous fryer 100. The plurality of chamber walls 122 may extend from the drum shaft 114 and radiate outwards to an outer edge 124 of the drum 110. Each chamber of the plurality of chambers 120 may have an end wall 126, defining an outer boundary of the chamber. The end wall 126 may also extend entirely across the width of the drum 110 and have a plane that is angled, with respect to the plurality of chamber walls 122, between 60-90 degrees. The end wall 126 may be angled so that the end wall 126 does not seal each chamber of the plurality of chambers 120. Instead, the angling of each end wall 126 allows an opening or slot to be formed between each end wall 126 and an adjacent end wall 126.

A drum gear motor 128 may be coupled to the drum shaft 114 and positioned outside, e.g., external to, the upper portion 102 of the rotating continuous fryer 100 at a first side surface 130 of the hood 116. The first side surface 130 and a second side surface 132 are co-planar and aligned parallel with a y-z plane. An upper surface 134 of the hood 116 may connect the first and second side surfaces 130, 132 and extend from the rear side 111 of the rotating continuous fryer 100 to the front side 113 of the rotating continuous fryer 100. The drum gear motor 128 arranged at the first side surface of the hood 116 may control rotation of the drum 110, rotating the drum in a desired direction and at a target speed when activated. By arranging the drum gear motor 128 at an external location along the upper portion 102, the drum gear motor 128 may be more accessible for routine maintenance and repair relative to drum motors arranged interior to surfaces of the rotating continuous fryer 100.

The lower portion 104 of the rotating continuous fryer 100 may be a base configured to support a weight of the rotating continuous fryer 100 and have a chamber, or reservoir, 136 for storing oil used to cook food items. The reservoir 136 is supported by the legs 115, the legs 115 coupled to an outer surface of the reservoir 36 and extending downwards between the reservoir 136 and a surface on which the rotating continuous fryer 100 is placed, such as a floor. The reservoir 136 may have a depth 138, defined along the y-axis, deep enough to submerge a portion of the drum 110 in oil. A heating element 140 may be positioned in the reservoir 136 to heat the oil. In one example, the heating element 140 may be a split immersion tube 140. The split immersion tube 140 may be a hollow device with an overall sinuous shape, winding across the second width 105 of the rotating continuous fryer 100 so that the split immersion tube 140 extends across most of the second width 105. The split immersion tube 140 may have a substantially planar main portion 142 that winds along the z-x, or horizontal, plane and side portions 144 that are continuous with the main portion 142 but aligned perpendicular to the main portion 142 and co-planar with a y-x, or vertical, plane.

The split immersion tube 140 may be arranged in the reservoir 136 so that the main portion 142 of the split immersion tube 140 is proximate to a floor 146 of the reservoir 136 of the rotating continuous fryer 100. The floor 146 may define a bottom of the reservoir 136, aligned co-planar with the z-x plane. The split immersion tube 140 may be spaced away from the floor 146 of the reservoir 136 by a small distance such as 5% of the depth 138 of the reservoir 136. The side portions 144 may be positioned proximate to but spaced away from a first wall 148 and a second wall 150 of the reservoir 136. A geometry of the split immersion tube 140 may affect how efficiently the split immersion tube 140 heats oil in the reservoir 136 of the rotating continuous fryer 100.

The split immersion tube 140 is shown in FIG. 2 disembodied from the rotating continuous fryer 100. In some examples, hollow tubing that may be an outer housing of the split immersion tube 140 may form a channel for heat flow. In one example, the split immersion tube 140 may be coupled to an external heat source such as a natural gas burner that ignites a fuel, such as natural gas, propane, butane, etc. Ignition of the fuel generates a flame and heated gases which are blown through the hollow tubing of the split immersion tube 140, thereby heating the hollow tubing. Heat absorbed by the hollow tubing radiates to a fluid, such as oil, in the reservoir 136.

The inlet port 202 may be an opening in a base plate 204 of the split immersion tube 140. The base plate 204 may be a planar, rigid plate of the split immersion tube 140 that provides support to the main portion 142 and side portions 144 of the split immersion tube 140 by coupling to the hollow tubing of the split immersion tube 140 at three regions. In FIG. 2, the base plate 204 is co-planar with the y-z plane and has a width 206, along the z-axis, that is adapted to be smaller than the first width 103 of the rotating continuous fryer 100 of FIG. 1 so the base plate 204 may fit within the reservoir 136 of the lower portion 104 of the rotating continuous fryer 100 as shown in FIG. 1. A height 208, measured along the y-axis, of the base plate 204 may be smaller in dimension than the width 206 of the base plate 204 but tall enough to allow the base plate 204 to couple to both the main portion 142 and the side portions 144 of the split immersion tube 140.

The base plate 204 is attached to the main portion 142 of the split immersion tube 140 at a first end 210 of a tube trunk 212. The main portion 142 of the of the split immersion tube 140 may be substantially co-planar with the horizontal plane and comprise the tube trunk 212 as a central section of the main portion 142 that extends linearly along the x-axis. The tube trunk 212 has a shape resembling a “y”, branching into winding sections of the main portion 142 that weave back and forth along the x-axis. At least a portion of the winding, branched sections of the main portion 142, described in detail further below, may be aligned along a different plane, e.g., not along the horizontal plane, at the side portions 144 of the split immersion tube 140. As such, the tube trunk 212 may be bifurcated such that the split immersion tube 140 may divide into two winding sections.

For example, as shown in FIG. 2, the side portions 144 extend upwards from the main portion 142 along the vertical plane, perpendicular to the main portion 142. That is to say, the side portions 144 may be vertically displaced relative to the main portion 142. In other examples, however, the side portions 144 may not be perpendicular to the main portion 142, and instead be aligned at less or greater than 90 degrees relative to the horizontal plane. In yet other examples, the split immersion tube 140 may have multiple sections that align with multiple, varying planes. For example, the y-shaped tube trunk 212 may branch into sections following a stepped geometry, with sections that are co-planar with the horizontal plane alternating with sections that are not co-planar with the horizontal plane. The sections that are not co-planar with the horizontal plane may be co-planar with the vertical plane or not perpendicular to the horizontal plane. Alternatively, the split immersion tube 140 may have sections that extend downwards from the horizontal plane of the main portion 142, at an angle with perpendicular to or not perpendicular to the horizontal plane. An overall geometry of the split immersion tube 140 may be based on a shape of a rotating drum, e.g., the drum 110 of FIG. 1, and a shape of an oil reservoir, e.g., the reservoir 136 of FIG. 1 of the rotating continuous fryer. Many variations in the geometry of the split immersion tube 140 have been contemplated.

In FIG. 2, the tube trunk 212 may be a hollow tube extending linearly along the x-axis from a central region of the base plate 204. At a second end 214 of the tube trunk 212, the split immersion tube 140 may split into a first branch 216 and a second branch 218. The first branch 216 and second branch 218 may also be formed from hollow tubing, seamlessly continuous with the tube trunk 212 but curving away from a central axis 220 of the split immersion tube 140 in opposite directions. The split immersion tube 140 may be mirror-symmetric about the central axis 220 so that the first branch 216 and second branch 218 are identical but extending in opposite directions along the z-axis. Thus the following description of the second branch 218 may be similarly applied to the first branch 216 along an oppositely arranged trajectory with respect to the z-axis.

The second branch 218 may have a first portion 222 of continuous tubing that is co-planar with the z-x plane and may curve away from the central axis at a first curved joint 221, coupled to the second end 214 of the tube trunk 212. The tubing of the first portion 222 of the second branch 218 winds back along the z-axis in a linear path towards the base plate 204, parallel with but spaced away from the tube trunk 212. As the tubing of the first portion 222 approaches the base plate 204, the first portion 222 curves so that the tubing does not come into contact with the base plate 204, forming a second curved joint 224 that has a semi-circular shape. The tubing of the second branch 218 extends linearly along the z-axis, parallel with and spaced away from the linear region of the first portion 222 of the second branch 218, forming a second portion 226 of the second branch 218 that is also one of the side portions 144 of the split immersion tube 140.

The tubing of the second portion 226 of the second branch 218 of the split immersion tube 140 may be aligned perpendicular to the plane of the first portion 222, the second portion 226 co-planar with the y-x plane. The second portion 226 winds back towards the base plate 204 at a third curved joint 228, the third curved joint 228 curving upwards, along the y-axis. The third curved joint 228 may be a similar distance, with respect to the x-axis, away from the base plate as the first curved joint 221. The tubing of the second portion 226 extends linearly to the base plate 204, coupling to a first surface 230 of the base plate 204, extending through a thickness, defined along the x-axis, of the base plate 204, and continuing a distance 234 beyond a second surface 232 of the base plate 204 to form one of the protrusions 235 both protrusions parallel with the x-axis. The distance 234 that the protrusions 235 extend from the base plate 204 may be much shorter than a length 236 of the spit immersion tube 140, also defined along the x-axis. A point at which the second portion 226 couples to the base plate 204 may be higher along the height 208 of the base plate 204 than the inlet port 202 of the base plate 204. The protrusions 235 may be coupled to the power source that is also coupled to the inlet port 202, thereby completing an electrical circuit of the split immersion tube 140.

The base plate 204, main portion 142, and side portions 144 of the split immersion tube 140 form a continuous, permanently joined unit. The heating element of the split immersion tube 140 may extend continuously through the tube trunk 212, first branch 216, and second branch 218 so that the tubing of the split immersion tube 140 is evenly heated throughout. A diameter of the tubing of the split immersion tube 140 may be uniform throughout the main portion 142 and side portions 144 or may vary. The base plate 204 and tubing of the split immersion tube 140 may be formed from a same, rigid, heat conducting material with high heat tolerance, such as stainless steel, or may be formed from different materials. For example, the tubing may be of stainless steel while the base plate 204 may be formed from a heavier, more durable material to provide structural support to the split immersion tube 140.

By configuring the split immersion tube as a single unit, the split immersion tube may be adapted as a cartridge that is readily installed and removed from the rotating continuous fryer. A heating element may be a component of an electrically powered cooking or frying system that is prone to degradation or deterioration over time with usage. Replacement of the heating element may be demanded with greater regularity than other parts of the system due to exposure of the heating element to high temperatures. Thus adapting the rotating continuous fryer with a heating element that is encased within a single unit of tubing to form a cartridge may allow the heating element to be quickly and completely exchanged when desired.

Furthermore, a geometry of the split immersion tube may enable even heat distribution, radiating from the heating element encased in the split immersion tube, throughout a volume of oil stored in the reservoir of the lower portion of the rotating continuous fryer. The sinuous pattern of the split immersion tube allows the split immersion tube to spread across the floor of the oil reservoir, heating the oil from a bottom of the volume of oil and inducing convective mixing of the oil. A likelihood of cooling of the oil at walls of the reservoir is decreased by configuring the side portions of the split immersion tube to extend vertically, with respect to the y-axis, along the walls of the reservoir, thereby assisting with heating the oil at regions of the reservoir where cooling of the oil is most likely to occur.

Returning to FIG. 1, the split immersion tube 140 may heat oil in the reservoir 136 of the lower portion 104 of the rotating continuous fryer 100 to fry food items in the plurality of chambers 120 of the drum 110. The food items may be delivered to the drum 110 at the front side 113, which may also be an inlet side 113 of the rotating continuous fryer through a gap in the hold 116 adapted with an inlet lip 158. The food items may be distributed into the plurality of chambers 120 of the drum 110 and become submerged in hot oil as the drum 110 rotates. When the food items emerge from the oil, also due to rotation of the drum 110 the plurality of walls 122 of the drum 110 may be angled such that the fried food items slide out of the drum 110 through gaps between each end walls 126 and an adjacent end wall 126, at the rear side 111, which may also be an outlet side 111 of the rotating continuous fryer 100. The food items may exit the drum 110 through a gap 154 in the upper portion 102 of the rotating continuous fryer 100 coupled to an outlet lip (shown in FIGS. 5 and 7.

The rotating continuous fryer 100 may also include a branched pipe 160 coupled to a side wall 162 of the lower portion 104 of the rotating continuous fryer 100. A lower, branched portion 164 of the branched pipe 160 may be attached to the side wall 162, fluidly coupling an inner volume of the branched 160 to an inner volume of the reservoir 136 through the side wall 162. The branched portion 164 of the branched pipe 160 may merge at an upper portion 166 that extends linearly upwards, along the y-axis, and above the lower portion 104 of the rotating continuous fryer 100. The branched pipe 160 may be an exhaust stack that couples to the split immersion tube 140 at protrusions (e.g., protrusions 235 shown in FIG. 2), through flange fittings (e.g., flange fittings 316 shown in FIG. 3) extending through openings in the side 162 of the lower portion 104 of the rotating continuous fryer 100.

The rotating continuous fryer 100 may be configured to open at the inlet side 113 with the hinge 106, about which the upper portion 102 is pivoted, arranged at the outlet side 111 of the rotating continuous fryer 100. Adapting the rotating continuous fryer 100 to pivot at the outlet side 111 may allow inner components of the rotating continuous fryer 100 to be accessed more readily with respect to processing instruments and systems directly coupled to the rotating continuous fryer 100 than, for example, when the rotating continuous fryer 100 is configured to pivot at the inlet side 113 instead. For example, opening the hood 116 towards a discharge side of the rotating continuous fryer 100, e.g., towards the outlet side 111 via the configuration shown in FIG. 1, allows opening of the hood 116 without first moving equipment feeding food items to the rotating continuous fryer 100. Thus, the rotating continuous fryer 100 may be easily integrated into food processing systems. Furthermore, gaining access to the rotating continuous fryer 100 is simplified when sanitation and emptying of a removable screen of the fryer is desired.

A coupling of a split immersion tube to an oil reservoir of a rotating continuous fryer and details of other components of the rotating continuous fryer are shown in a second embodiment of a rotating continuous fryer 302 in FIGS. 3-7 and are discussed collectively in the following description. The rotating continuous fryer 302 of FIGS. 3-7 may be similar to the rotating continuous fryer 100 of FIG. 1 but the rotating continuous fryer 302 of FIGS. 3-7 may also include a basket 301 (omitted in FIGS. 3, 6, and 7 for brevity). The basket 301 may be used to maintain food items within chambers of a rotating drum 303 of the rotating continuous fryer 302 so that the food items do not fall into an oil reservoir 312, the oil reservoir 312 disposed in a lower portion 306 of the rotating continuous fryer 302. The basket 301 may be shaped to match a lower portion of the drum 303 so that the drum 303 may rotate within the basket 301 with the basket 301 submerged in the oil reservoir 312. The basket 301 may be adapted with perforations to allow oil to flow across through surfaces of the basket 301 so that oil inside the basket 301 is fluidly coupled to oil outside of the basket 301.

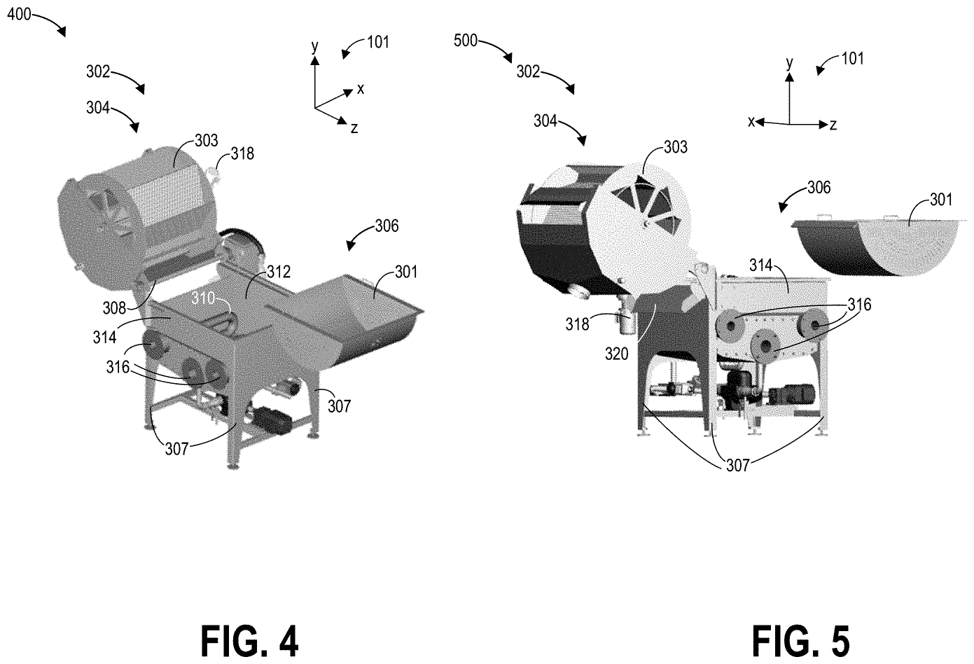

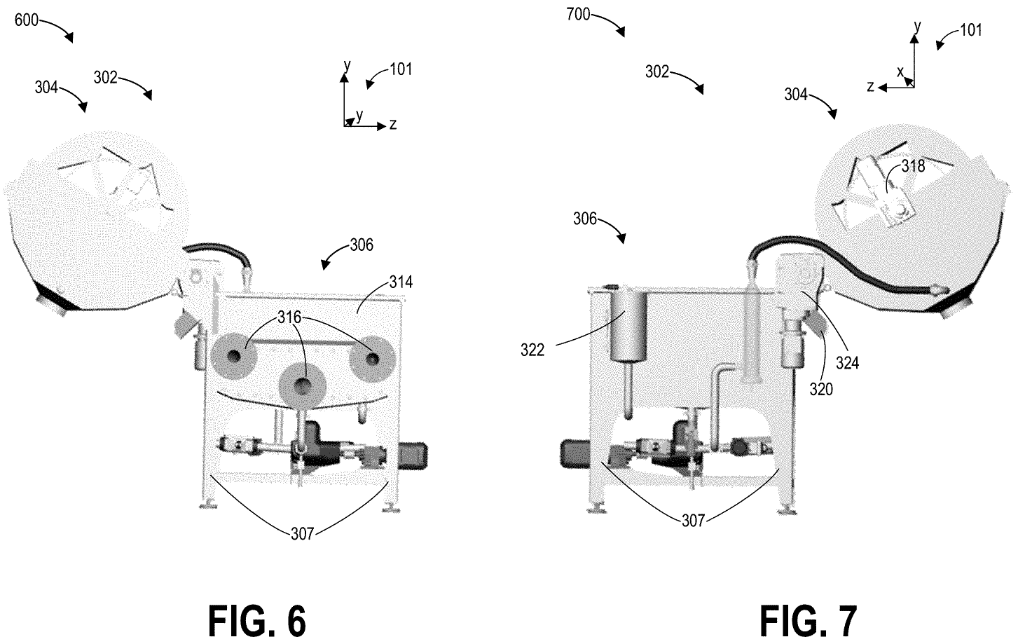

The rotating continuous fryer 302 is depicted from a top-down view 300 in FIG. 3, a first perspective view 400 in FIG. 4, a second perspective view 500 in FIG. 5, a first side view 600 in FIG. 6, and a second side view 700 in FIG. 7. The rotating continuous fryer 302 is shown in an open position, e.g., with an upper portion 304 pivoted away from the lower portion 306 about a hinge 308. The upper portion 304 includes the rotating drum 303 and the lower portion 306 includes legs 307, shown in FIGS. 4-7, arranged below the oil reservoir 312, configured to support the lower portion 306 and upper portion 304. A split immersion tube 310, which may be the split immersion tube 140 of FIGS. 1 and 2, may be arranged in the oil reservoir 312 as shown in FIG. 3, placed proximate to a bottom of the oil reservoir 312, with respect to the y-axis, and spreading across an entire surface area of the bottom of the oil reservoir 312. The split immersion tube 310 may be secured to a wall 314 of the lower portion 306 of the rotating continuous fryer 302 by aligning an inlet port, e.g., the inlet port 202 of FIG. 2, and protrusions, e.g., the protrusion 235 of FIG. 2, of the split immersion tube 310 with apertures in the wall 314 of the lower portion 306 of the rotating continuous fryer 302. The protrusions may be inserted through the apertures and both the protrusions and the inlet port may be coupled to the flange fittings 316 that attach the split immersion tube 310 to the wall 314. The flange fittings 316 may be bolted to the wall 314 to secure a positioning of the split immersion tube 310.

The rotating continuous fryer 302 may also include a drum gear motor 318 for actuating rotation of the drum 303, an outlet lip 320 for channeling food items into the drum 303, an oil level indicator 322, and a gear motor 324 for pivoting the upper portion 304 of the rotating continuous fryer 302 around the hinge 308. In some examples, the rotating continuous fryer 302 may also have a branched pipe, such as the branched pipe 160 of FIG. 1, coupled to the wall 314 (or another wall) of the lower portion 306 of the rotating continuous fryer 302 to circumvent overfilling or overflow of oil.

In this way, a rotating continuous fryer may be configured to cook food items consistently and efficiently by providing even, rapid heating of oil stored in a reservoir of the fryer. The fryer may include a split immersion tube to heat the oil, positioned in a lower region of the reservoir and submerged in the oil. A sinuous, branched geometry of the split immersion tube allows the split immersion tube to cover a surface area of a floor of the reservoir while side portions of the split immersion tube, oriented perpendicular to the floor of the reservoir, extend upwards along two oppositely arranged side walls of the reservoir. The side portions of the split immersion tube, continuous with a main portion of the split immersion tube that is co-planar with the reservoir floor, mitigate undesired cooling of oil at the side walls of the reservoir, thus increasing heating efficiency of the split immersion tube. The split immersion tube may be a single, continuous unit, allowing easy removal and installation of a new split immersion tube when replacement of the tube is desired. In addition, the rotating continuous fryer is adapted to open at an outlet side of the fryer, allowing inner components of the fryer to be readily accessed.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A continuous fryer, comprising:
a lower portion, configured with a reservoir to store oil;
an upper portion, coupled to the lower portion via a hinge and pivotable relative to the lower portion about the hinge; and
an immersion tube arranged in the lower portion, configured to heat the oil in the reservoir, the immersion tube adapted with a sinuous, branched geometry.

2. The continuous fryer of claim 1, wherein the immersion tube is positioned adjacent to a floor of the reservoir and the immersion tube winds across the floor of the reservoir.

3. The continuous fryer of claim 1, wherein the immersion tube comprises a central portion co-planar with a horizontal plane, wherein the central portion includes a y-shaped section of tubing.

4. The continuous fryer of claim 3, wherein the central portion is coupled to bends of the immersion tube that are aligned with planes set at angles relative to the horizontal plane.

5. The continuous fryer of claim 1, wherein the immersion tube comprises two or more side portions aligned perpendicular to a horizontal plane and the floor of the reservoir, wherein the side portions extend in an upward direction toward the upper portion.

6. The continuous fryer of claim 1, wherein the immersion tube comprises a continuous hollow outer casing flowing ignited gases from an external heat source.

7. The continuous fryer of claim 1, wherein the hinge is positioned at an outlet side of the fryer where objects exit the fryer.

8. The continuous fryer of claim 1, wherein the upper portion is pivotable away from the lower portion at an inlet side of the fryer where objects enter the fryer.

9. The continuous fryer of claim 1, wherein the upper portion includes a drum rotatable about a shaft that moves objects in a circular direction through the fryer.

10. The continuous fryer of claim 9, wherein a lower portion of the drum is enclosed in the reservoir of the lower portion of the fryer and submerged in oil.

11. A heating tube for a fryer, comprising:
a main portion forming a sinuous pattern;
a set of side portions, continuous with the main portion and aligned with a second plane different than a first plane aligned with the main portion; and
a base plate coupled to both the planar portion and the set of side portions.

12. The heating tube of claim 11, wherein the main portion includes a tube trunk that extends linearly from an inlet opening of the heating tube.

13. The heating tube of claim 12, wherein the tube trunk comprises a bifurcation and is y-shaped.

14. The heating tube of claim 13, wherein the tube trunk branches into a first branch and a second branch, wherein the first branch and second branch curve away from the tube trunk in opposite directions so that the heating tube is mirror-symmetric about an axis aligned with the tube trunk, wherein the first branch and the second branch direct a heated gas in opposite directions away from the bifurcation of the tube trunk.

15. The heating tube of claim 14, wherein the first branch and second branch each include one side portion of the set of side portions, wherein the set of side portions extend in a direction perpendicular to the main portion and parallel to the second plane on opposite sides of the main portion of the heating tube.

16. The heating tube of claim 14, wherein the base plate has apertures adapted to match diameters of the tube trunk, the first branch, and the second branch at regions where the base plate couples to the tube trunk and outlet ends of the first branch and second branch.

17. The heating tube of claim 14, wherein the base plate, the tube trunk, and the first and second branches form a single, continuous unit.

18. A rotating continuous frying system, comprising:
an outer housing adapted to open at an inlet side of the outer housing;
a rotating drum positioned within an upper portion of the outer housing, wherein the upper portion of the outer housing is configured to pivot away from the lower portion of the outer housing at a hinge arranged at an outlet side, wherein the outlet side is opposite of the inlet side of the outer housing, wherein a drum motor gear is coupled to the rotating drum and positioned external to the upper portion along the outer housing;
an oil reservoir positioned in a lower portion if the outer housing and configured to submerge a lower portion of the rotating drum; and
a heating cartridge arranged in the oil reservoir, wherein the heating cartridge is formed from rigid tubing with a branched sinuous pattern coupled to a base plate.

19. The rotating continuous frying system of claim 18, wherein the rotating drum is configured to receive objects at the inlet side of the outer housing and in chambers of the rotating drum and eject objects at the outlet side of the outer housing.

20. The rotating continuous frying system of claim 18, wherein the heating cartridge is coupled to a wall of the lower portion of the outer housing by flange fittings.
